(19) United States
(12) Patent Application Publication
(10) Pub. No.: US 2023/0245183 A1
(43) Pub. Date: Aug. 3, 2023

(54) SYSTEMS AND METHODS FOR GENERATING VEHICLE BUYBACK GUARANTEES

(71) Applicant: Capital One Services, LLC, McLean, VA (US)

(72) Inventors: Vijay Viswanathan, McKinney, TX (US); Gunjan Patel, McKinney, TX (US); Jason-Vi Tuan Dang, Irving, TX (US)

(21) Appl. No.: 17/588,415

(22) Filed: Jan. 31, 2022

(51) Int. Cl. G06Q 30/02; G06F 3/0482; G06N 20/20

(52) U.S. Cl. CPC G06Q 30/0283; G06Q 30/0278; G06F 3/0482; G06N 20/20

(57) ABSTRACT

A system may generate buyback guarantee options for a particular vehicle, each option based on a user satisfying respective predetermined condition(s). The system may receive a user selection at a future date claiming one of the guarantee options. The system may determine whether the user satisfied the applicable predetermined condition(s), and whether the buyback guarantee price is greater than the current selling price of the vehicle. Responsive to such determinations, the system may provide the user with payment option(s) for receiving the difference between the buyback guarantee price and the vehicle current selling price.

The disclosed technology relates to systems and methods for generating vehicle buyback guarantees, and in particular, for generating vehicle buyback guarantee options for a customer based on the satisfaction of one or more predetermined conditions.

### BACKGROUND

Traditional systems and methods for generating vehicle buyback guarantees typically take place at the time a customer wishes to place a previously purchased vehicle back on the market. As such, while these systems and methods may take into account certain existing features of the vehicle, such as mileage, accident history, make, model, etc., customers are not provided an understanding of the potential resell value of their vehicle until the time they wish to resell. At the same time, these customers are typically not provided options for different future resell value options at the time they first purchase a vehicle.

Accordingly, there is a need for improved systems and methods for generating vehicle buyback guarantees. Embodiments of the present disclosure are directed to this and other considerations.

### SUMMARY

Disclosed embodiments may include a system for generating vehicle buyback guarantees. The system may include one or more processors, and memory in communication with the one or more processors and storing instructions that, when executed by the one or more processors, are configured to cause the system to perform a method for generating vehicle buyback guarantee options. The system may receive, via a first graphical user interface (GUI) of a user device, a first user selection associated with a first vehicle. The system may generate, using a first decision tree machine learning model (MLM), two or more buyback guarantee options, wherein each buyback guarantee option comprises a price at which a first user may sell back the first vehicle at a future date, and is based on the first user satisfying one or more predetermined conditions (e.g., duration, mileage, service history, maintenance history, property loss, casualty loss, insurance requirements, etc.). The system may cause the user device to display, via the first GUI, the two or more buyback guarantee options. The system may receive, via the first GUI, a second user selection associated with a first buyback guarantee option of the two or more buyback guarantee options. The system may receive, via a second GUI of the user device, a third user selection associated with the first user attempting to claim the price associated with the first buyback guarantee option after the future date associated with the first buyback guarantee option. The system may determine, using a second decision tree MLM, whether the first user satisfied the one or more predetermined conditions associated with the first buyback guarantee option. Responsive to determining the first user satisfied the one or more predetermined conditions associated with the first buyback guarantee option, the system may determine, using a third MLM, whether the price associated with the first buyback guarantee option is greater than a current selling price of the first vehicle. Responsive to determining the price associated with the first buyback guarantee option is greater than the current selling price of the first vehicle, the system may cause the user device to display, via the second GUI, one or more payment options for receiving a payment amount comprising a difference between the price associated with the first buyback guarantee option and the current selling price. The one or more payment options may comprise, for example, receiving a mailed check, a direct deposit, a credit, an offer, a reward, and the like. Additionally, responsive to determining the price associated with the first buyback guarantee option is greater than the current selling price of the first vehicle, the system may receive, via the second GUI, a fourth user selection corresponding to a first payment option of the one or more payment options; and may transmit the payment amount to the first user according to the first payment option.

In another embodiment, the system may include one or more processors, and memory in communication with the one or more processors and storing instructions that, when executed by the one or more processors, are configured to cause the system to perform a method for generating vehicle buyback guarantee options. The system may receive, via a first GUI of a user device, a first user selection associated with a first vehicle. The system may generate, using a first vector MLM, two or more buyback guarantee options, wherein each buyback guarantee option comprises a price at which a first user may sell back the first vehicle at a future date, and is based on the first user satisfying one or more predetermined conditions. The system may cause the user device to display, via the first GUI, the two or more buyback guarantee options. The system may receive, via the first GUI, a second user selection associated with a first buyback guarantee option of the two or more buyback guarantee options. The system may receive, via a second GUI of the user device, a third user selection associated with the first user attempting to claim the price associated with the first buyback guarantee option after the future date associated with the first buyback guarantee option. The system may determine, using a second vector MLM, whether the first user satisfied the one or more predetermined conditions associated with the first buyback guarantee option. Responsive to determining the first user satisfied the one or more predetermined conditions associated with the first buyback guarantee option, the system may transmit a payment amount to the first user.

In another embodiment, the system may include one or more processors, and memory in communication with the one or more processors and storing instructions that, when executed by the one or more processors, are configured to cause the system to perform a method for generating vehicle buyback guarantee options. The system may receive, via a first GUI of a user device, a first user selection associated with a first vehicle. The system may generate, using a first MLM, two or more buyback guarantee options, wherein each buyback guarantee option comprises a price at which a first user may sell back the first vehicle at a future date, and is based on the first user satisfying one or more predetermined conditions. The system may cause the user device to display, via the first GUI, the two or more buyback guarantee options. The system may receive, via the first GUI, a second user selection associated with a first buyback guarantee option of the two or more buyback guarantee options.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a block diagram of an example system that may be used to generate vehicle buyback guarantees, according to an example implementation of the disclosed technology.

FIG. 2 is a block diagram of an example buyback guarantee generation system used to generate buyback guarantee options, according to an example implementation of the disclosed technology.

FIGS. 3A-3B are a flow diagram illustrating an exemplary method for generating vehicle buyback guarantees, in accordance with certain embodiments of the disclosed technology.

FIG. 4 is a flow diagram illustrating an exemplary method for generating vehicle buyback guarantees, in accordance with certain embodiments of the disclosed technology.

FIG. 5 is a flow diagram illustrating an exemplary method for generating vehicle buyback guarantees, in accordance with certain embodiments of the disclosed technology.

### DETAILED DESCRIPTION

Examples of the present disclosure relate to systems and methods for generating vehicle buyback guarantees. In particular, the disclosed technology relates to systems and methods for generating buyback guarantee options for a particular vehicle, each option based on a user satisfying one or more respective predetermined conditions; receiving a user selection at a future date claiming one of the guarantee options; determining whether the user satisfied the applicable predetermined conditions; determining whether the buyback guarantee price is greater than the current selling price of the vehicle; and responsive to one or both determinations, providing the user with payment options for receiving the difference between the buyback guarantee price and the vehicle current selling price. The systems and methods described herein are necessarily rooted in computer and technology as they utilize MLMs to generate vehicle buyback guarantee options based on whether a user satisfies one or more predetermined conditions prior to reselling a vehicle. Machine learning models are a unique computer technology that involves training the models to complete tasks, such as labeling, categorizing, identifying, or determining whether certain predetermined conditions (e.g., mileage, service history, accident history, etc.) influence predicted buyback guarantee options so the MLMs learn how to label, categorize, identify, or determine whether incorporating such predetermined conditions may help to accurately predict a future price of a vehicle.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

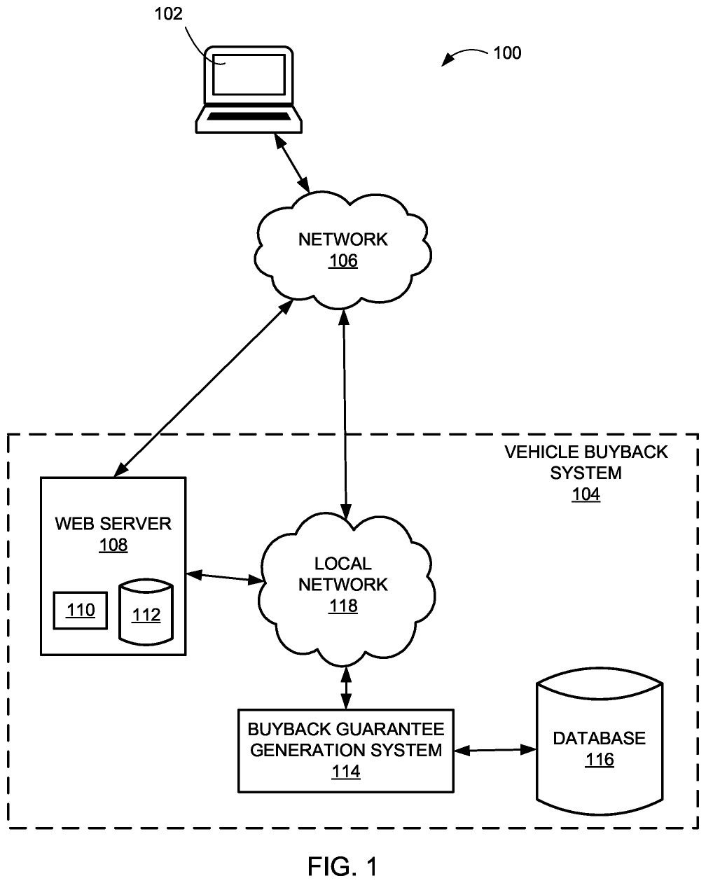

FIG. 1 is a block diagram of an example system that may be used to generate vehicle buyback guarantees, according to an example implementation of the disclosed technology. The components and arrangements shown in FIG. 1 are not intended to limit the disclosed embodiments as the components used to implement the disclosed processes and features may vary. As shown, a user device 102 may communicate with a vehicle buyback system 104 via a network 106. In certain example implementations, the vehicle buyback system 104 may include a web server 108, a buyback guarantee generation system 114, a database 116, and a local network 118.

In some embodiments, a user may operate the user device 102. The user device 102 can include one or more of a mobile device, smart phone, general purpose computer, tablet computer, laptop computer, telephone, PSTN landline, smart wearable device, voice command device, other mobile computing device, or any other device capable of communicating with network 106 and ultimately communicating with one or more components of the vehicle buyback system 104. In some embodiments, the user device 102 may include or incorporate electronic communication devices for hearing or vision impaired users.

Customers may include individuals such as, for example, subscribers, clients, prospective clients, or customers of an entity associated with an organization, such as individuals who have obtained, will obtain, or may obtain a product, service, or consultation from or conduct a transaction in relation to an entity associated with the vehicle buyback system 104. According to some embodiments, the user device 102 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

Network 106 may be of any suitable type, including individual connections via the internet such as cellular or WiFi networks. In some embodiments, network 106 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, universal serial bus (USB), wide area network (WAN), or local area network (LAN). Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Network 106 may include any type of computer networking arrangement used to exchange data. For example, network 106 may be the Internet, a private data network, virtual private network using a public network, and/or other suitable connection(s) that enable(s) components in the system 100 environment to send and receive information between the components of system 100. Network 106 may also include a public switched telephone network (“PSTN”) and/or a wireless network.

Vehicle buyback system 104 may be associated with and optionally controlled by one or more entities such as a business, corporation, individual, partnership, or any other entity that provides one or more of goods, services, and consultations to individuals such as customers. In some embodiments, vehicle buyback system 104 may be controlled by a third party on behalf of another business, corporation, individual, or partnership. Vehicle buyback system 104 may include one or more servers and computer systems for performing one or more functions associated with products and/or services that the organization provides.

Web server 108 may include a computer system configured to generate and provide one or more websites accessible to customers, as well as any other individuals involved in accessing system 100's normal operations. Web server 108 may include a computer system configured to receive communications from user device 102 via for example, a mobile application, a chat program, an instant messaging program, a voice-to-text program, an SMS message, email, or any other type or format of written or electronic communication. Web server 108 may have one or more processors 110 and one or more web server databases 112, which may be any suitable repository of website data. Information stored in web server 108 may be accessed (e.g., retrieved, updated, and added to) via local network 118 and/or network 106 by one or more devices or systems (e.g., buyback guarantee generation system 114) of system 100. In some embodiments, web server 108 may host websites or applications that may be accessed by user device 102. For example, web server 108 may host a financial service provider website that a user device may access by providing an attempted login that is authenticated by buyback guarantee generation system 114. According to some embodiments, web server 108 may include software tools, similar to those described with respect to user device 102 above, that may allow web server 108 to obtain network identification data from user device 102.

Local network 118 may include any type of computer networking arrangement used to exchange data in a localized area, such as WiFi, Bluetooth™ Ethernet, and other suitable network connections that enable components of vehicle buyback system 104 to interact with one another and to connect to network 106 for interacting with components in the system 100 environment. In some embodiments, local network 118 may include an interface for communicating with or linking to network 106. In other embodiments, certain components of vehicle buyback system 104 may communicate via network 106, without a separate local network 118.

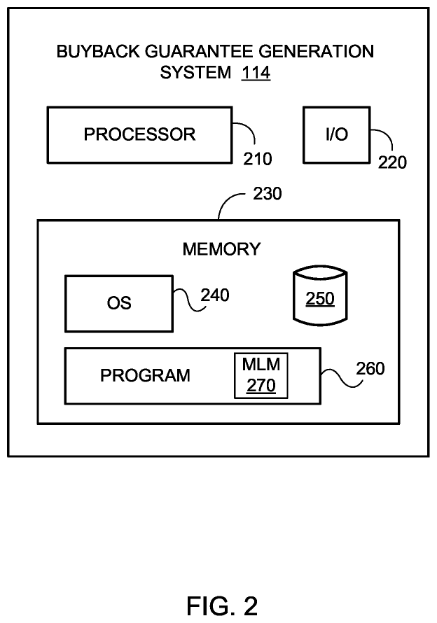

In accordance with certain example implementations of the disclosed technology, vehicle buyback system 104 may include one or more computer systems configured to compile data from a plurality of sources, for example, buyback guarantee generation system 114, web server 108, and/or database 116. Buyback guarantee generation system 114 may correlate compiled data, analyze the compiled data, arrange the compiled data, generate derived data based on the compiled data, and store the compiled and derived data in a database such as database 116. According to some embodiments, database 116 may be a database associated with an organization and/or a related entity that stores a variety of information relating to customers, transactions, trainings, and business operations. Database 116 may also serve as a back-up storage device and may contain data and information that is also stored on, for example, database 250, as discussed below with reference to FIG. 2.

Although the preceding description describes various functions of a web server 108, a buyback guarantee generation system 114, and a database 116, in some embodiments, some or all of these functions may be carried out by a single computing device or a plurality of computing devices in a (cloud) serverless system.

An example embodiment of buyback guarantee generation system 114 is shown in more detail in FIG. 2. According to some embodiments, user device 102 and web server 108, as depicted in FIG. 1 and described above, may have a similar structure and components that are similar to those described with respect to buyback guarantee generation system 114 shown in FIG. 2. As shown, buyback guarantee generation system 114 may include a processor 210, an input/output (“I/O”) device 220, a memory 230 containing an operating system (“OS”) 240, a database 250, and a program 260. In some embodiments, program 260 may include an MLM 270 that may be trained, for example, to generate vehicle buyback guarantee options for a customer, as further discussed below. In certain implementations, MLM 270 may issue commands in response to processing an event, in accordance with a model that may be continuously or intermittently updated. Moreover, processor 210 may execute one or more programs (such as via a rules-based platform or the trained MLM 270), that, when executed, perform functions related to disclosed embodiments.

In certain example implementations, buyback guarantee generation system 114 may be a single server or may be configured as a distributed computer system including multiple servers or computers that interoperate to perform one or more of the processes and functionalities associated with the disclosed embodiments. In some embodiments, buyback guarantee generation system 114 may be one or more servers from a serverless or scaling server system. In some embodiments, buyback guarantee generation system 114 may further include a peripheral interface, a transceiver, a mobile network interface in communication with processor 210, a bus configured to facilitate communication between the various components of buyback guarantee generation system 114, and a power source configured to power one or more components of buyback guarantee generation system 114.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a USB port, a micro-USB port, a high-definition multimedia (HDMI) port, a video port, an audio port, a Bluetooth™ port, an NFC port, another like communication interface, or any combination thereof.

In some embodiments, a transceiver may be configured to communicate with compatible devices and ID tags when they are within a predetermined range. A transceiver may be compatible with one or more of: RFID, NFC, Bluetooth™, BLE, WiFi™, ZigBee™, ABC protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within memory 230.

Processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. Processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, processor 210 may be a single core processor that is configured with virtual processing technologies. In certain embodiments, processor 210 may use logical processors to simultaneously execute and control multiple processes. Processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, buyback guarantee generation system 114 may include one or more storage devices configured to store information used by processor 210 (or other components) to perform certain functions related to the disclosed embodiments. In one example, buyback guarantee generation system 114 may include memory 230 that includes instructions to enable processor 210 to execute one or more applications, such as server applications, network communication processes, and any other type of application or software known to be available on computer systems. Alternatively, the instructions, application programs, etc., may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, buyback guarantee generation system 114 may include a memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, buyback guarantee generation system 114 may include memory 230 that may include one or more programs 260 to perform one or more functions of the disclosed embodiments. For example, in some embodiments, buyback guarantee generation system 114 may additionally manage dialogue and/or other interactions with the customer via a program 260.

Processor 210 may execute one or more programs located remotely from buyback guarantee generation system 114. For example, buyback guarantee generation system 114 may access one or more remote programs that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. Memory 230 may include software components that, when executed by processor 210, perform one or more processes consistent with the disclosed embodiments. In some embodiments, memory 230 may include database 250 for storing related data to enable buyback guarantee generation system 114 to perform one or more of the processes and functionalities associated with the disclosed embodiments.

Buyback guarantee generation system 114 may also be communicatively connected to one or more memory devices (e.g., databases) locally or through a network. The remote memory devices may be configured to store information and may be accessed and/or managed by buyback guarantee generation system 114. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

Buyback guarantee generation system 114 may also include one or more I/O devices 220 that may comprise one or more interfaces for receiving signals or input from devices and providing signals or output to one or more devices that allow data to be received and/or transmitted by buyback guarantee generation system 114. For example, buyback guarantee generation system 114 may include interface components, which may provide interfaces to one or more input devices, such as one or more keyboards, mouse devices, touch screens, track pads, trackballs, scroll wheels, digital cameras, microphones, sensors, and the like, that enable buyback guarantee generation system 114 to receive data from a user (such as, for example, via user device 102).

In example embodiments of the disclosed technology, buyback guarantee generation system 114 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While buyback guarantee generation system 114 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of buyback guarantee generation system 114 may include a greater or lesser number of components than those illustrated.

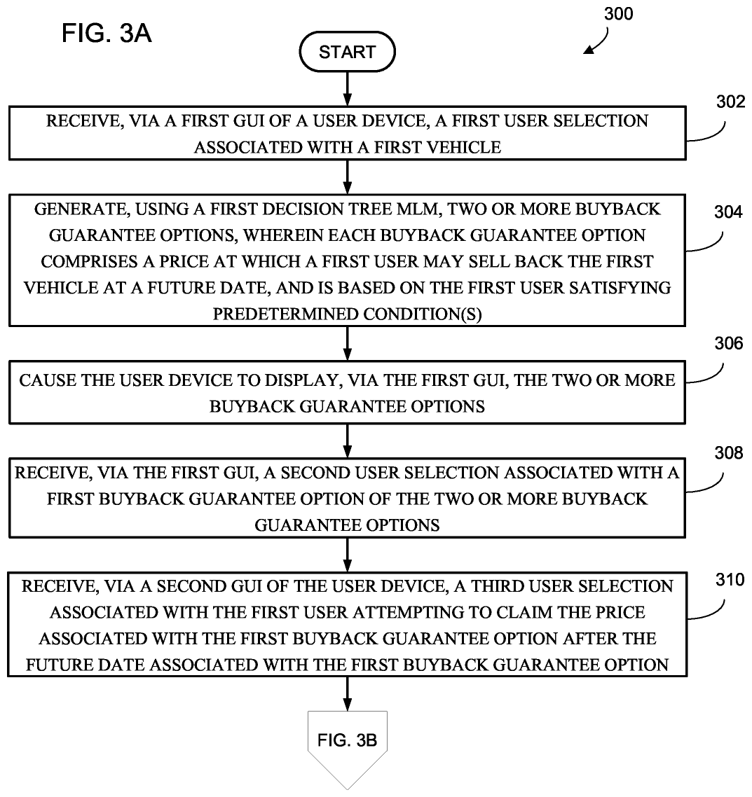

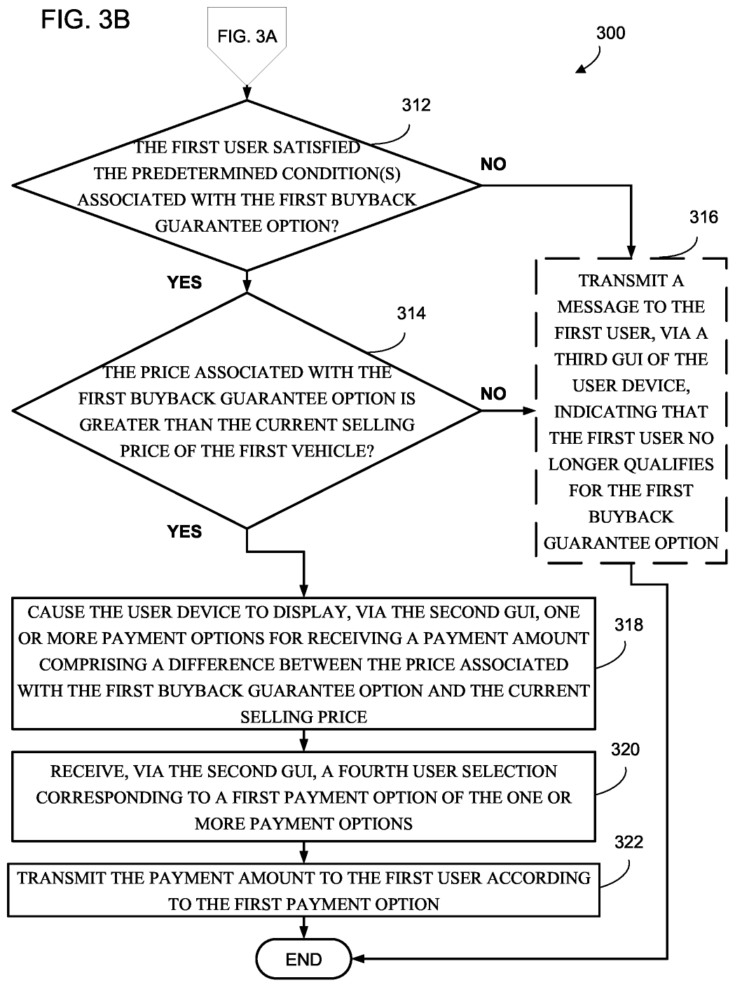

FIGS. 3A-3B provide a flow diagram illustrating an exemplary method 300 for generating vehicle buyback guarantees, in accordance with certain embodiments of the disclosed technology. Method 300 may be performed by one or more components of system 100 (e.g., web server 108 or buyback guarantee generation system 114 of vehicle buyback system 104, or user device 102), as described above with respect to FIGS. 1 and 2.

In block 302 of FIG. 3A, the system (e.g., via vehicle buyback system 104) may receive, via a first GUI of a user device (e.g., user device 102), a first user selection associated with a first vehicle. For example, a user may access or log into an application (e.g., a website, account, browser plugin, etc.), such as one owned and/or operated by vehicle buyback system 104, associated with vehicle selection (e.g., buying, leasing, renting, etc.). The first GUI may be configured such that the user may search for particular vehicles, e.g., by make, model, color, mileage, price, etc. The user may select a specific vehicle, e.g., via a button, a dropdown menu, etc., such that additional details pertaining to that vehicle are displayed on the GUI, as further discussed below.

In block 304, the system (e.g., via buyback guarantee generation system 114) may generate, using a first MLM, two or more buyback guarantee options, wherein each buyback guarantee option comprises a price at which a first user may sell back the first vehicle at a future date, and is based on the first user satisfying one or more predetermined conditions. The one or more predetermined conditions may comprise duration, mileage, service history, maintenance history, property loss, casualty loss, insurance requirements, make of vehicle, model of vehicle, and the like. Such predetermined conditions may be configured in groups such that each generated buyback guarantee option corresponds to a different combination or threshold of conditions. The future date options may be, for example, at the 3-year mark, 5-year mark, 10-year mark, etc. For example, a first generated buyback guarantee option may indicate that if the user agrees to drive the selected vehicle less than 35,000 miles over the next 3 years, and to maintain a certain auto insurance package, the user may be entitled to receive a buyback guarantee of $22,000 after 3 years. A second generated buyback guarantee option may indicate that if the user agrees to drive the selected vehicle less than 60,000 miles over the next 5 years, to maintain a certain auto insurance package, and to have the vehicle serviced at least annually, the user may be entitled to receive a buyback guarantee of $18,000.

The system may use a trained MLM to generate the two or more buyback guarantee options. The MLM may be trained via a two-part learning algorithm including a semi-supervised learning algorithm and an unsupervised learning algorithm. As part of the semi-supervised learning algorithm, a streaming queue (e.g., Python®) may first be used to stream data, such as data from dealers, customers, Fair Isaac Corporation (FICO®) scoring, etc., into the algorithm. A streaming data platform (e.g., Kafka®) may then be used for streaming the data inside the semi-supervised learning algorithm. The semi-supervised learning algorithm may be used for a certain period of time (e.g., three months) to aid in filtering the streaming data and ensuring the MLM learns how to achieve specific results, such as intended returns on investments (ROI). Once the MLM has been adequately trained via the semi-supervised learning algorithm, an unsupervised learning algorithm, such as a decision tree model or a vector model, may be implemented. In using an unsupervised learning algorithm, the MLM may receive a new data stream. This new data stream may comprise feedback, e.g., from dealers, as to how customers are handling their vehicle loan obligations after receiving and selecting a buyback guarantee option. The MLM may then be trained to generate future buyback guarantee options for customers based on analyzing this new data stream.

In block 306, the system (e.g., via vehicle buyback system 104) may cause the user device to display, via the first GUI, the two or more buyback guarantee options. That is, after the system generates the buyback guarantee options for a specific vehicle, as discussed above, the system may cause the user device to display those options, for example, as part of the additional details displayed proximate a selected vehicle, as discussed above with respect to block 302.

In block 308, the system (e.g., via vehicle buyback system 104) may receive, via the first GUI, a second user selection associated with a first buyback option of the two or more buyback guarantee options. That is, after the system causes the user device to display the generated buyback guarantee options, as discussed above, the system may receive a user selection indicating the user's interest in one of those options. For example, the user, via the GUI, may be provided with a click or radio button, a dropdown menu, etc., to select one of the buyback guarantee options.

In block 310, the system (e.g., via buyback guarantee generation system 114) may receive, via a second GUI of the user device, a third user selection associated with the first user attempting to claim the price associated with the first buyback guarantee option after the future date associated with the first buyback guarantee option. For example, if a user had previously selected the first buyback guarantee option (as outlined above in block 304), the user may, at the end of the 3-year period, once again access the system, for example by logging back into the application, to resell the vehicle and claim the $22,000 buyback guarantee price.

Turning to FIG. 3B, in block 312, the system (e.g., via vehicle buyback system 104) may determine, using a second MLM, whether the first user satisfied the one or more predetermined conditions associated with the first buyback guarantee option. The system may make this determination by, for example, reviewing previously tracked user data associated with the vehicle, prompting the user to answer a series of questions and/or to upload vehicle information, or contacting a third-party dealer associated with the user's specific vehicle (e.g., the dealer from whom the user originally purchased the vehicle). The second MLM may be trained in the same or similar fashion as discussed above with respect to block 304.

In block 314, the system (e.g., via vehicle buyback system 104) may determine whether the price associated with the first buyback guarantee option is greater than the current selling price of the first vehicle. For example, the system may communicate directly with the third-party dealer to whom the user resells the first vehicle to determine how much the dealer was willing to pay for the vehicle in its current condition. If the user resells the vehicle to the dealer for a selling price that is lower than the first buyback guarantee option, the system may ultimately pay the user the difference between the lower selling price and the first buyback guarantee option, as further discussed below. In some embodiments, the system may make this determination responsive to determining the first user satisfied the one or more predetermined conditions associated with the first buyback guarantee option, as discussed above with respect to block 312.

In block 316, in response to determining the first user did not satisfy the one or more predetermined conditions associated with the first buyback guarantee option (block 312) and/or the price associated with the first buyback guarantee option is not greater than the current selling price of the first vehicle (block 314), the system (e.g., via vehicle buyback system 104) may transmit a message to the first user, via a third GUI of the user device, indicating that the first user no longer qualifies for the first buyback guarantee option. That is, if the user failed to satisfy the one or more predetermined conditions upon which the initially offered buyback guarantee price was based, the user may no longer claim that buyback guarantee price. Additionally or alternatively, if the initially offered buyback guarantee price is not greater than the current selling price of the vehicle, indicating a dealer would pay the same or more for the vehicle compared to the initially offered buyback guarantee price, then again the user may no longer claim that buyback guarantee price. In some embodiments, the system may transmit the message to the first user by way of, e.g., an email, a chat box, an in-application message or alert, etc.

In block 318, responsive to determining the price associated with the first buyback guarantee option is greater than the current selling price of the first vehicle, the system (e.g., via vehicle buyback system 104) may cause the user device to display, via the second GUI, one or more payment options for receiving a payment amount associated with the first buyback guarantee option. The one or more payment options may comprise, for example, receiving a mailed check, a direct deposit, a credit, an offer, a reward, etc. These options may be displayed to the user in various formats, such as a click or radio button, a dropdown menu, etc., such that the user may select how he or she would prefer to receive payment. In some embodiments, the payment amount may be equal to the difference between the price associated with the first buyback guarantee option (i.e., the initially offered price) and a dealer's current selling price. That is, as discussed above, the user may be able to resell the vehicle to a third-party dealer, yet for a lower price than the first buyback guarantee option. In such case, the system may offer to pay the user the difference between that lower selling price and the first buyback guarantee option price.

In block 320, the system (e.g., via vehicle buyback system 104) may receive, via the second GUI, a fourth user selection corresponding to a first payment option of the one or more payment options. That is, the user may select how he or she would prefer to receive the payment, as discussed above with respect to block 318.

In block 322, the system (e.g., via vehicle buyback system 104) may transmit the payment amount to the first user according to the first payment option. Depending on which payment method the user selects, the system may be configured to collect payment information associated with the user (e.g., mailing address, account number, etc.) by, for example, retrieving existing payment information from a user account or profile, or prompting the user to enter new payment information. Once the system collects the appropriate payment information, the system may transmit the payment amount according to the selected payment option. For example, if the user selects “direct deposit” as the payment method, the system may either retrieve account information the user previously entered into a profile or account, or prompt the user to enter account information (e.g., account number, routing number) such that the system may transmit payment directly to the appropriate account. In some embodiments, the selection of payment methods and/or entering of payment information may be customizable by the user.

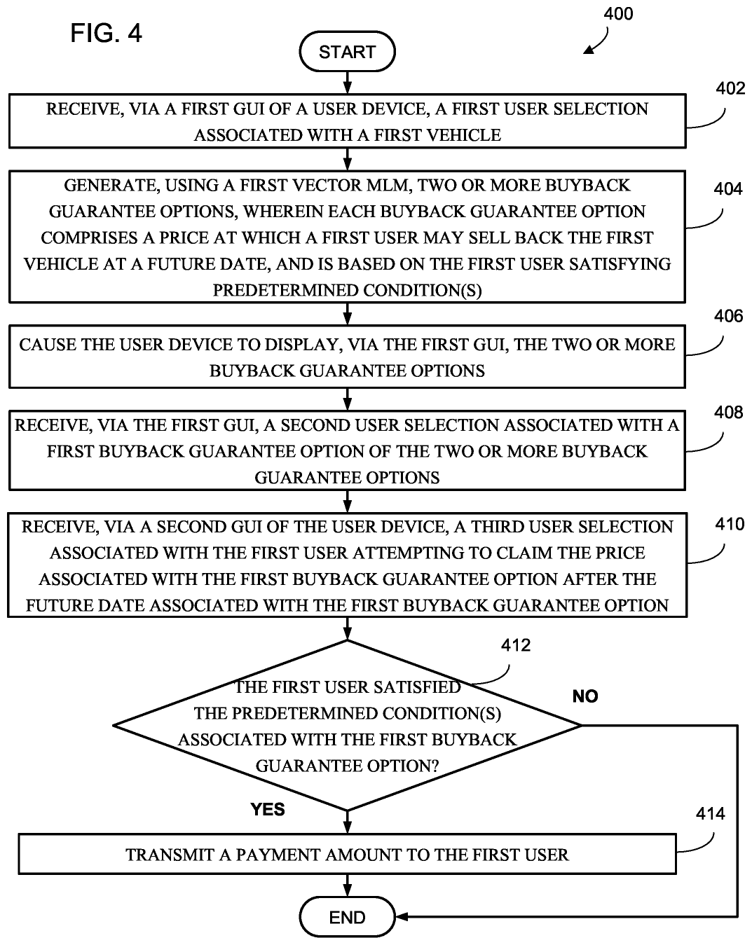

Method 400 of FIG. 4 is similar to method 300 of FIG. 3, except that method 400 does not include determining whether the price associated with the first buyback guarantee option is greater than the current selling price of the first vehicle, or providing the user with payment options for receiving the payment amount. The descriptions of blocks 402, 404, 406, 408, 410, and 412 may be the same as or similar to the respective descriptions of blocks 302, 304, 306, 308, 310, and 312 of method 300 and as such, are not repeated herein for brevity.

In block 414, the system (e.g., via vehicle buyback system 104) may transmit the payment amount to the first user. In some embodiments, unlike in block 322 discussed above, the first user may not be presented with payment options for receiving the payment amount. The first user may instead, for example, have previously entered payment preferences (e.g., in a user profile), or may receive payment from the system via a default payment option.

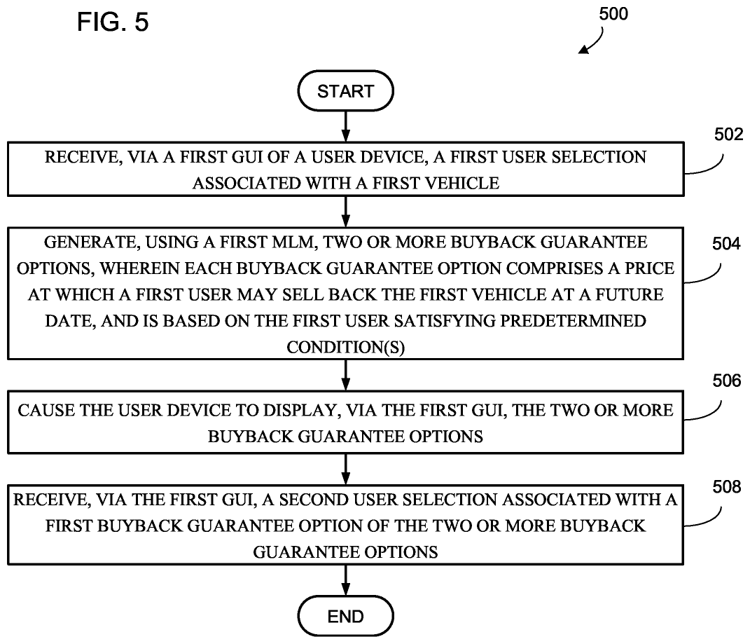

Method 500 of FIG. 5 is also similar to method 300 of FIG. 3, except that method 500 does not include receiving a future user selection claiming the price associated with the first buyback guarantee price, determining whether the user satisfied the one or more predetermined conditions associated with the first buyback guarantee, determining whether the price associated with the first buyback guarantee option is greater than the current selling price of the first vehicle, or providing the user with payment options for receiving the payment amount. The descriptions of blocks 502, 504, 506, and 508 may be the same as or similar to the respective descriptions of blocks 302, 304, 306, and 308 of method 300 and as such, are not repeated herein for brevity.

Example Use Case

The following example use case describes an example of a typical user flow pattern. This section is intended solely for explanatory purposes and not in limitation.

In one example, a user may use a personal laptop to access a vehicle search system owned and operated by an organization, such as a financial institution. The user may search for vehicles to purchase based on, e.g., make, model, and color. When the user finds a vehicle he is interest in purchasing, the user may select the vehicle by clicking on a selector button displayed proximate the vehicle listing. Additional details pertaining to the selected vehicle may then be displayed on the screen, such as financing and dealer options. The system may also generate, using a trained MLM, two or more buyback guarantee options, each option associated with a price at which the user may resell the vehicle at a future date (e.g., 3 years, 5 years, etc.), and based on whether the user satisfies one or more specified conditions (e.g., mileage, service package, insurance coverage, etc.). These buyback guarantee options may be displayed proximate the selected vehicle on the system screen such that the user may read through the details of each. The user may then select one of the displayed buyback guarantee options, such as a price of $15,000 after 3 years if the user drives the selected vehicle less than 25,000 miles, and maintains a certain servicing package through the provided dealer. The user may then purchase the vehicle through the organization and/or the provided dealer under these conditions.

Following the 3-year period, the user may return to the vehicle search system, or may directly contact the organization, to claim the $15,000 buyback guarantee price. The user may attempt to claim the price by, for example, logging into a personal account within the system and clicking on a selector button in the user's profile displayed proximate the user's previously purchased vehicle. The system may then determine whether the user satisfied the conditions applicable to the selected buyback guarantee, i.e., drove the vehicle less than 25,000 miles and maintained the certain servicing package through the provided dealer over the 3-year period. The system may make this determination by prompting the user to answer a series of questions and to upload documentary evidence of such answers, or by contacting the dealer (e.g., the dealer to whom the vehicle is sold) to confirm such information. If the system determines the user did satisfy the applicable conditions, the system may then determine whether the buyback guarantee price ($15,000) is greater than the dealer's selling price of the vehicle. If the system determines the buyback guarantee price is greater than the dealer's selling price, for example $13,500, the system may display for the user, within the vehicle search system, one or more payment options for receiving payment for the difference between the buyback guarantee price and the dealer's selling price, i.e., $1,500. That is, if the user resells the vehicle to the dealer at the dealer's lower selling price, the organization would be responsible for making up the difference such that the user ends up with the full amount of the initially offered buyback guarantee price. The provided payment options may be, for example, receiving a check in the mail, or receiving a direct deposit into a selected account. The user may select the mailed check payment option, and may then be prompted by the system to enter a mailing address where the user would like to receive the check. The user may be able to enter a new address, or may be able to indicate that the system should use an address already on file within the user's system account. Once the user finishes selecting his preferred payment method, and entering or indicating his preferred address, the system may transmit the $1,500 payment to the user via a physical mailed check.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive, via a first graphical user interface (GUI) of a user device, a first user selection associated with a first vehicle; generate, using a first decision tree machine learning model (MLM), two or more buyback guarantee options, wherein each buyback guarantee option comprises a price at which a first user may sell back the first vehicle at a future date, and is based on the first user satisfying one or more predetermined conditions; cause the user device to display, via the first GUI, the two or more buyback guarantee options; receive, via the first GUI, a second user selection associated with a first buyback guarantee option of the two or more buyback guarantee options; receive, via a second GUI of the user device, a third user selection associated with the first user attempting to claim the price associated with the first buyback guarantee option after the future date associated with the first buyback guarantee option; determine, using a second decision tree MLM, whether the first user satisfied the one or more predetermined conditions associated with the first buyback guarantee option; responsive to determining the first user satisfied the one or more predetermined conditions associated with the first buyback guarantee option, determine, using a third MLM, whether the price associated with the first buyback guarantee option is greater than a current selling price of the first vehicle; and responsive to determining the price associated with the first buyback guarantee option is greater than the current selling price of the first vehicle: cause the user device to display, via the second GUI, one or more payment options for receiving a payment amount comprising a difference between the price associated with the first buyback guarantee option and the current selling price; receive, via the second GUI, a fourth user selection corresponding to a first payment option of the one or more payment options; and transmit the payment amount to the first user according to the first payment option.

Clause 2: The system of clause 1, wherein the one or more payment options for receiving the payment amount comprise one or more of a mailed check, a direct deposit, a credit, an offer, a reward, or combinations thereof.

Clause 3: The system of clause 1, wherein the one or more predetermined conditions comprise one or more of duration, mileage, service history, maintenance history, property loss, casualty loss, insurance requirements, or combinations thereof.

Clause 4: The system of clause 1, wherein the instructions are further configured to cause the system to: responsive to determining the first user did not satisfy the one or more predetermined conditions associated with the first buyback guarantee option, transmit a message to the first user, via a third GUI of the user device, indicating that the first user no longer qualifies for the first buyback guarantee option.

Clause 5: The system of clause 1, wherein the instructions are further configured to cause the system to: responsive to determining the price associated with the first buyback guarantee option is not greater than the current selling price of the first vehicle, transmit a message to the first user, via a third GUI of the user device, indicating that the first user no longer qualifies for the first buyback guarantee option.

Clause 6: A system comprising: one or more processors; and a memory in communication with the one or more processors and storing instructions that, when executed by the one or more processors, are configured to cause the system to: receive, via a first graphical user interface (GUI) of a user device, a first user selection associated with a first vehicle; generate, using a first vector machine learning model (MLM), two or more buyback guarantee options, wherein each buyback guarantee option comprises a price at which a first user may sell back the first vehicle at a future date, and is based on the first user satisfying one or more predetermined conditions; cause the user device to display, via the first GUI, the two or more buyback guarantee options; receive, via the first GUI, a second user selection associated with a first buyback guarantee option of the two or more buyback guarantee options; receive, via a second GUI of the user device, a third user selection associated with the first user attempting to claim the price associated with the first buyback guarantee option after the future date associated with the first buyback guarantee option; determine, using a second vector MLM, whether the first user satisfied the one or more predetermined conditions associated with the first buyback guarantee option; and responsive to determining the first user satisfied the one or more predetermined conditions associated with the first buyback guarantee option, transmit a payment amount to the first user.

Clause 7: The system of clause 6, wherein the one or more predetermined conditions comprise one or more of duration, mileage, service history, maintenance history, property loss, casualty loss, insurance requirements, or combinations thereof.

Clause 8: The system of clause 6, wherein the instructions are further configured to cause the system to: responsive to determining the first user satisfied the one or more predetermined conditions associated with the first buyback guarantee option, determine, using a third vector MLM, that the price associated with the first buyback guarantee option is greater than a current selling price of the first vehicle, wherein the payment amount comprises a difference between the price associated with the first buyback guarantee option and the current selling price.

Clause 9: The system of clause 6, wherein the instructions are further configured to cause the system to: responsive to determining the price associated with the first buyback guarantee option is greater than a current selling price of the first vehicle: cause the user device to display, via the second GUI, one or more payment options for receiving the payment amount; and receive, via the second GUI, a fourth user selection corresponding to a first payment option of the one or more payment options, wherein transmitting the payment amount to the first user is conducted according to the first payment option.

Clause 10: The system of clause 9, wherein the one or more payment options for receiving the payment amount comprise one or more of a mailed check, a direct deposit, a credit, an offer, a reward, or combinations thereof.

Clause 11: The system of clause 6, wherein the instructions are further configured to cause the system to: responsive to determining the first user did not satisfy the one or more predetermined conditions associated with the first buyback guarantee option, transmit a message to the first user, via a third GUI of the user device, indicating that the first user no longer qualifies for the first buyback guarantee option.

Clause 12: A system comprising: one or more processors; and a memory in communication with the one or more processors and storing instructions that, when executed by the one or more processors, are configured to cause the system to: receive, via a first graphical user interface (GUI) of a user device, a first user selection associated with a first vehicle; generate, using a first machine learning model (MLM), two or more buyback guarantee options, wherein each buyback guarantee option comprises a price at which a first user may sell back the first vehicle at a future date, and is based on the first user satisfying one or more predetermined conditions; cause the user device to display, via the first GUI, the two or more buyback guarantee options; and receive, via the first GUI, a second user selection associated with a first buyback guarantee option of the two or more buyback guarantee options.

Clause 13: The system of clause 12, wherein the one or more predetermined conditions comprise one or more of duration, mileage, service history, maintenance history, property loss, casualty loss, insurance requirements, or combinations thereof.

Clause 14: The system of clause 12, wherein the instructions are further configured to cause the system to: receive, via a second GUI of the user device, a third user selection associated with the first user attempting to claim the price associated with the first buyback guarantee option after the future date associated with the first buyback guarantee option.

Clause 15: The system of clause 14, wherein the instructions are further configured to cause the system to: responsive to receiving the third user selection, determine, using a second MLM, whether the price associated with the first buyback guarantee option is greater than a current selling price of the first vehicle; and responsive to determining the price associated with the first buyback guarantee option is not greater than the current selling price of the first vehicle, transmit a message to the first user, via a third GUI of the user device, indicating that the first user no longer qualifies for the first buyback guarantee option.

Clause 16: The system of clause 14, wherein the instructions are further configured to cause the system to: responsive to receiving the third user selection, determine, using a second MLM, whether the first user satisfied the one or more predetermined conditions associated with the first buyback guarantee option; and responsive to determining the first user satisfied the one or more predetermined conditions associated with the first buyback guarantee option, transmit a payment amount to the first user.

Clause 17: The system of clause 16, wherein the instructions are further configured to cause the system to: responsive to determining the first user did not satisfy the one or more predetermined conditions associated with the first buyback guarantee option, transmit a message to the first user, via a third GUI of the user device, indicating that the first user no longer qualifies for the first buyback guarantee option.

Clause 18: The system of clause 16, wherein the instructions are further configured to cause the system to: responsive to determining the first user satisfied the one or more predetermined conditions associated with the first buyback guarantee option, determine, using a third MLM, whether the price associated with the first buyback guarantee option is greater than a current selling price of the first vehicle; and responsive to determining the price associated with the first buyback guarantee option is greater than the current selling price of the first vehicle: cause the user device to display, via the second GUI, one or more payment options for receiving the payment amount.

Clause 19: The system of clause 18, wherein the instructions are further configured to cause the system to: receive, via the second GUI, a fourth user selection corresponding to a first payment option of the one or more payment options; and transmit the payment amount to the first user according to the first payment option, wherein the payment amount comprises a difference between the price associated with the first buyback guarantee option and the current selling price.

Clause 20: The system of clause 12, wherein the first MLM comprises a decision tree model or a vector model.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive, via a first graphical user interface (GUI) of a user device, a first user selection associated with a first vehicle;
generate, using a first decision tree machine learning model (MLM), two or more buyback guarantee options, wherein each buyback guarantee option comprises a price at which a first user may sell back the first vehicle at a future date, and is based on the first user satisfying one or more predetermined conditions;
cause the user device to display, via the first GUI, the two or more buyback guarantee options;
receive, via the first GUI, a second user selection associated with a first buyback guarantee option of the two or more buyback guarantee options;
receive, via a second GUI of the user device, a third user selection associated with the first user attempting to claim the price associated with the first buyback guarantee option after the future date associated with the first buyback guarantee option;
determine, using a second decision tree MLM, whether the first user satisfied the one or more predetermined conditions associated with the first buyback guarantee option;
responsive to determining the first user satisfied the one or more predetermined conditions associated with the first buyback guarantee option, determine, using a third MLM, whether the price associated with the first buyback guarantee option is greater than a current selling price of the first vehicle; and
responsive to determining the price associated with the first buyback guarantee option is greater than the current selling price of the first vehicle:
cause the user device to display, via the second GUI, one or more payment options for receiving a payment amount comprising a difference between the price associated with the first buyback guarantee option and the current selling price;
receive, via the second GUI, a fourth user selection corresponding to a first payment option of the one or more payment options; and
transmit the payment amount to the first user according to the first payment option.

2. The system of claim 1, wherein the one or more payment options for receiving the payment amount comprise one or more of a mailed check, a direct deposit, a credit, an offer, a reward, or combinations thereof.

3. The system of claim 1, wherein the one or more predetermined conditions comprise one or more of duration, mileage, service history, maintenance history, property loss, casualty loss, insurance requirements, or combinations thereof.

4. The system of claim 1, wherein the instructions are further configured to cause the system to:
responsive to determining the first user did not satisfy the one or more predetermined conditions associated with the first buyback guarantee option, transmit a message to the first user, via a third GUI of the user device, indicating that the first user no longer qualifies for the first buyback guarantee option.

5. The system of claim 1, wherein the instructions are further configured to cause the system to:
responsive to determining the price associated with the first buyback guarantee option is not greater than the current selling price of the first vehicle, transmit a message to the first user, via a third GUI of the user device, indicating that the first user no longer qualifies for the first buyback guarantee option.

6. A system comprising:
one or more processors; and
a memory in communication with the one or more processors and storing instructions that, when executed by the one or more processors, are configured to cause the system to:
receive, via a first graphical user interface (GUI) of a user device, a first user selection associated with a first vehicle;
generate, using a first vector machine learning model (MLM), two or more buyback guarantee options, wherein each buyback guarantee option comprises a price at which a first user may sell back the first vehicle at a future date, and is based on the first user satisfying one or more predetermined conditions;
cause the user device to display, via the first GUI, the two or more buyback guarantee options;
receive, via the first GUI, a second user selection associated with a first buyback guarantee option of the two or more buyback guarantee options;
receive, via a second GUI of the user device, a third user selection associated with the first user attempting to claim the price associated with the first buyback guarantee option after the future date associated with the first buyback guarantee option;
determine, using a second vector MLM, whether the first user satisfied the one or more predetermined conditions associated with the first buyback guarantee option; and
responsive to determining the first user satisfied the one or more predetermined conditions associated with the first buyback guarantee option, transmit a payment amount to the first user.

7. The system of claim 6, wherein the one or more predetermined conditions comprise one or more of duration, mileage, service history, maintenance history, property loss, casualty loss, insurance requirements, or combinations thereof.

8. The system of claim 6, wherein the instructions are further configured to cause the system to:
responsive to determining the first user satisfied the one or more predetermined conditions associated with the first buyback guarantee option, determine, using a third vector MLM, that the price associated with the first buyback guarantee option is greater than a current selling price of the first vehicle,
wherein the payment amount comprises a difference between the price associated with the first buyback guarantee option and the current selling price.

9. The system of claim 6, wherein the instructions are further configured to cause the system to:
responsive to determining the price associated with the first buyback guarantee option is greater than a current selling price of the first vehicle:
cause the user device to display, via the second GUI, one or more payment options for receiving the payment amount; and
receive, via the second GUI, a fourth user selection corresponding to a first payment option of the one or more payment options,
wherein transmitting the payment amount to the first user is conducted according to the first payment option.

10. The system of claim 9, wherein the one or more payment options for receiving the payment amount comprise one or more of a mailed check, a direct deposit, a credit, an offer, a reward, or combinations thereof.

11. The system of claim 6, wherein the instructions are further configured to cause the system to:
responsive to determining the first user did not satisfy the one or more predetermined conditions associated with the first buyback guarantee option, transmit a message to the first user, via a third GUI of the user device, indicating that the first user no longer qualifies for the first buyback guarantee option.

12. A system comprising:
one or more processors; and
a memory in communication with the one or more processors and storing instructions that, when executed by the one or more processors, are configured to cause the system to:
receive, via a first graphical user interface (GUI) of a user device, a first user selection associated with a first vehicle;
generate, using a first machine learning model (MLM), two or more buyback guarantee options, wherein each buyback guarantee option comprises a price at which a first user may sell back the first vehicle at a future date, and is based on the first user satisfying one or more predetermined conditions;
cause the user device to display, via the first GUI, the two or more buyback guarantee options; and
receive, via the first GUI, a second user selection associated with a first buyback guarantee option of the two or more buyback guarantee options.

13. The system of claim 12, wherein the one or more predetermined conditions comprise one or more of duration, mileage, service history, maintenance history, property loss, casualty loss, insurance requirements, or combinations thereof.

14. The system of claim 12, wherein the instructions are further configured to cause the system to:
receive, via a second GUI of the user device, a third user selection associated with the first user attempting to claim the price associated with the first buyback guarantee option after the future date associated with the first buyback guarantee option.

15. The system of claim 14, wherein the instructions are further configured to cause the system to:
responsive to receiving the third user selection, determine, using a second MLM, whether the price associated with the first buyback guarantee option is greater than a current selling price of the first vehicle; and
responsive to determining the price associated with the first buyback guarantee option is not greater than the current selling price of the first vehicle, transmit a message to the first user, via a third GUI of the user device, indicating that the first user no longer qualifies for the first buyback guarantee option.

16. The system of claim 14, wherein the instructions are further configured to cause the system to:
responsive to receiving the third user selection, determine, using a second MLM, whether the first user satisfied the one or more predetermined conditions associated with the first buyback guarantee option; and
responsive to determining the first user satisfied the one or more predetermined conditions associated with the first buyback guarantee option, transmit a payment amount to the first user.

17. The system of claim 16, wherein the instructions are further configured to cause the system to:
responsive to determining the first user did not satisfy the one or more predetermined conditions associated with the first buyback guarantee option, transmit a message to the first user, via a third GUI of the user device, indicating that the first user no longer qualifies for the first buyback guarantee option.

18. The system of claim 16, wherein the instructions are further configured to cause the system to:
responsive to determining the first user satisfied the one or more predetermined conditions associated with the first buyback guarantee option, determine, using a third MLM, whether the price associated with the first buyback guarantee option is greater than a current selling price of the first vehicle; and
responsive to determining the price associated with the first buyback guarantee option is greater than the current selling price of the first vehicle:
cause the user device to display, via the second GUI, one or more payment options for receiving the payment amount.

19. The system of claim 18, wherein the instructions are further configured to cause the system to:
receive, via the second GUI, a fourth user selection corresponding to a first payment option of the one or more payment options; and
transmit the payment amount to the first user according to the first payment option,
wherein the payment amount comprises a difference between the price associated with the first buyback guarantee option and the current selling price.

20. The system of claim 12, wherein the first MLM comprises a decision tree model or a vector model.
